(19) United States
(12) Patent Application Publication
(10) Pub. No.: US 2004/0208412 A1
(43) Pub. Date: Oct. 21, 2004

(54) Optical path control device

(75) Inventors: Shun-ichi Miyazaki, Tokyo (JP); Akira Miura, Tokyo (JP); Shinji Kobayashi, Tokyo (JP); Morio Wada, Tokyo (JP); Tsuyoshi Yakihara, Tokyo (JP); Sadaharu Oka, Tokyo (JP); Shinji Iio, Tokyo (JP); Chie Sato, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Musashino-shi (JP)

(21) Appl. No.: 10/813,123

(22) Filed: Mar. 31, 2004

(30) Foreign Application Priority Data
Apr. 21, 2003 (JP) 2003-115625

(51) Int. Cl. G02F 1/295; G02B 6/26

(52) U.S. Cl. 385/9; 385/36

(57) ABSTRACT

According to this invention, electrodes are formed on both sides of a part of an optical waveguide formed on a substrate and a voltage is applied between the electrodes to change the refractive index at the part of the optical waveguide where the electrode is formed. Therefore, the traveling direction of light can be changed. Moreover, an optical waveguide formed on a substrate, plural electrodes formed on both sides of the optical waveguide, plural incidence units formed at one end of the substrate, and plural emission units formed at the other end are provided. A voltage applied to an arbitrary electrode of the plural electrodes is controlled to change the refractive index at the part of the optical waveguide where the voltage is applied. Light emitted from an arbitrary incidence unit and incident on a core of the substrate thus becomes incident on an arbitrary emission unit. As the position of incidence of incident light or the diameter of the incident light is controlled to emit light to an arbitrary emission unit, an optical switch is realized that has a high degree of freedom in control, is small-sized, has no moving part and has high reliability. Moreover, as a voltage application unit is provided with an algorithm-based optimization processing function in order to improve the responsiveness and the degree of freedom of the optical switch, a highly flexible optical switch that can cope with, for example, changes in communication quantity and communication failure, is realized.

### BACKGROUND OF THE INVENTION

1. Field of the Invention

This invention relates to an optical path control device that can be suitably used in an optical router or the like for future high-speed optical communication.

2. Description of the Prior Art

A conventional technique of forming an optical waveguide on a semiconductor, then injecting carriers into the semiconductor to change the refractive index, and thus switching the transmission path of an optical signal, is described in the following patent document 1.

Patent document 1: JP-A-4-320219

FIG. 1 is a plan view showing the structure of an essential part of an optical path control device (optical switch) used in an optical router or the like for conventional high-speed optical communication, produced by a fine processing technique.

In FIG. 1, an input port is provided, for example, on the left side of a silicon substrate 20 formed in a square shape. In the input port, n (in FIG. 1, n=7) incidence units 21a to 21g are arranged in an array, each of which includes an optical fiber and collimating lens.

An output port is provided on the lower side of this substrate 20. In the output port, n (in FIG. 1, n=7) emission units 22a to 22g are arranged in an array, each of which includes a similar optical fiber and collimating lens.

On the substrate 20, micro mirrors 23a to 23g are formed perpendicularly to the surface of the substrate. The micro mirrors are arranged so that light beams emitted from the incidence units 21a to 21g are reflected by these micro mirrors and become incident on the emission units 22a to 22g arranged in the output port.

In the above-described conventional optical switch, in order to change the traveling direction of light, n×n two-dimensional mirrors must be formed, corresponding to the prepared n incidence units and n emission units (optical fibers with cell photic lenses) existing in the incidence side and emission side, respectively.

However, this structure has the following problems.

1) To form two-dimensional mirrors, two-dimensional planar mirrors must be installed upright by using tweezers or the like, and as this work is carried out for n×n mirrors, the number of production steps increases and the reliability of the device is lowered.

2) Since the angle of the mirrors is fixed, light from an emission unit at an arbitrary position cannot be emitted.

### SUMMARY OF THE INVENTION

It is an object of this invention to realize an optical path control device that can solve the foregoing problems at the same time.

According to this invention, there is provided an optical path control device comprising an optical waveguide having a clad layer of P-type (or N-type) formed on a substrate and a core layer of N-type (or P-type) stacked on the clad layer, and electrodes formed on both sides of a part of the optical waveguide, wherein a voltage is applied between the electrodes to change the refractive index at the part of the optical waveguide where the electrode is formed, thus changing the traveling direction of light traveling through the optical waveguide.

Moreover, plural electrodes are formed on both sides of the optical waveguide. Plural incidence units are provided at one end of the substrate and plural emission units are provided at the other end. A voltage applied to an arbitrary electrode of the plural electrodes is controlled to change the refractive index at the part where the electrode is formed. Light emitted from an arbitrary incidence unit thus becomes incident on an arbitrary emission unit.

As the upper electrode on the substrate is formed in a triangular shape, the position of incident light incident on the optical waveguide or the spot diameter of the incident light is controlled, or the voltage applied to the electrode is controlled by using an algorithm function, the traveling direction of the incident light is controlled.

### BRIEF DESCRIPTION OF THE DRAWINGS

FIG. 1 is a plan view showing an example of a conventional optical path control device.

FIG. 2 is a plan view showing an example embodying an optical path control device according to this invention.

FIG. 3 is a partial sectional view of FIG. 2.

FIG. 4 is a plan view showing another example of the optical path control device according to this invention.

### DETAILED DESCRIPTION OF THE PREFERRED EMBODIMENTS

An example embodying an optical path control device according to this invention will now be described with reference to the drawings.

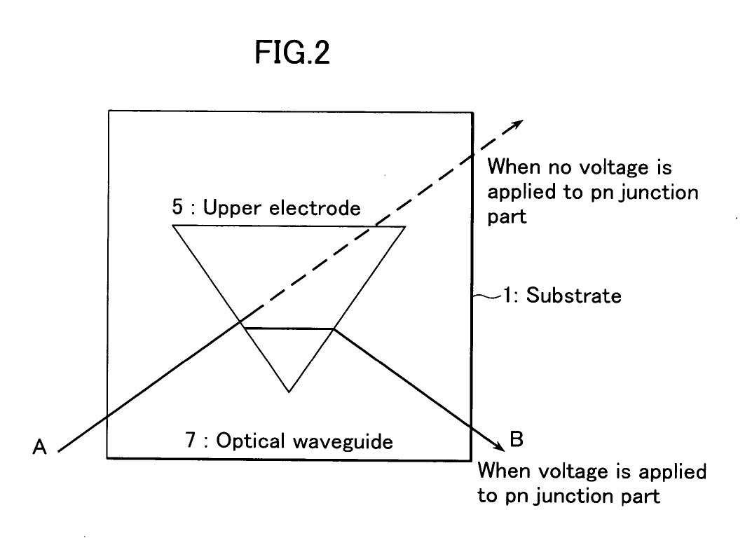

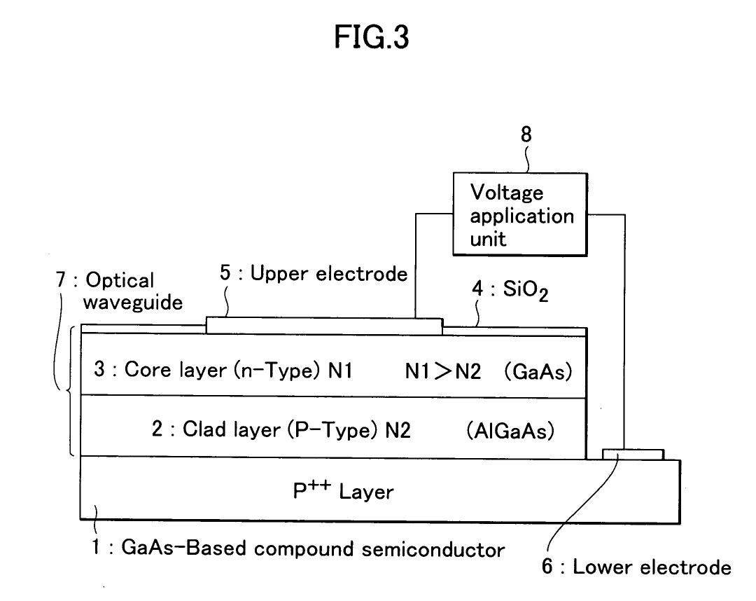

FIG. 2 is a plan view showing an essential part of an example embodying the optical path control device of this invention. FIG. 3 is an enlarged sectional view showing a part of FIG. 2.

In FIGS. 2 and 3, a P-type semiconductor layer 2 made of AlGaAs having a refractive index N2 is formed on the entire surface of a P⁺⁺GaAs-based compound semiconductor substrate 1. This P-type semiconductor layer 2 functions as a clad layer of an optical waveguide.

A GaAs semiconductor layer 3 of N-types having a refractive index N1 is formed over the clad layer 2. This semiconductor layer 3 functions as a core of an optical waveguide.

A SiO₂ layer 4 having a refractive index N3 is formed over the core layer 3. The refractive indexes of the clad layer 2, core layer 3 and SiO₂ layer 4 are in the relations of N1>N2 and N1>N3. These layers form an optical waveguide 7. A triangular part of the SiO₂ layer is removed and an upper electrode 5 is formed in the place from which the part of the SiO₂ layer has been removed. A lower electrode 6 is formed on the substrate 1 formed by the P⁺⁺ layer, and this P⁺⁺ layer functions as the lower electrode. A voltage application unit 8 is to apply a voltage between the upper electrode 5 and the lower electrode 6. It has a function of controlling the voltage.

In the above-described structure, light is made incident on the core layer 3 from an end part of the substrate. When no voltage is applied between the upper electrode 5 and the lower electrode 6, light passing below the triangular upper electrode 5 travels straight through the core layer.

When a voltage is applied between the upper electrode 5 and the lower electrode 6, the refractive index changes at the part of the optical waveguide where the triangular upper electrode 5 is formed. As a result, light is refracted into the direction of arrow B. The direction of refraction varies, depending on the shape of the triangle, the position of incidence, and the intensity of the voltage applied between the electrodes.

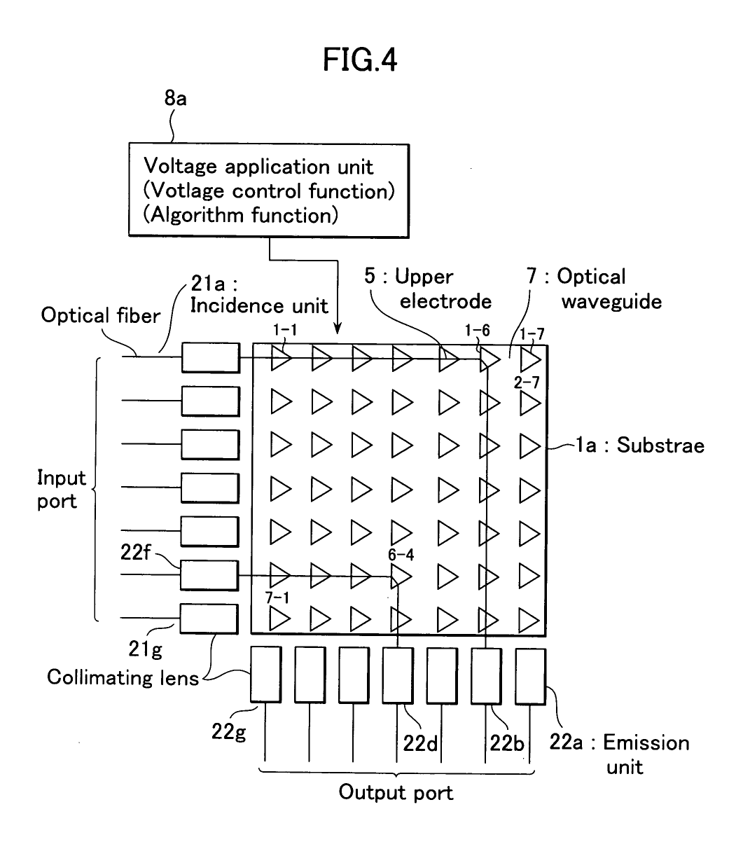

FIG. 4 is a plan view showing another example embodying this invention.

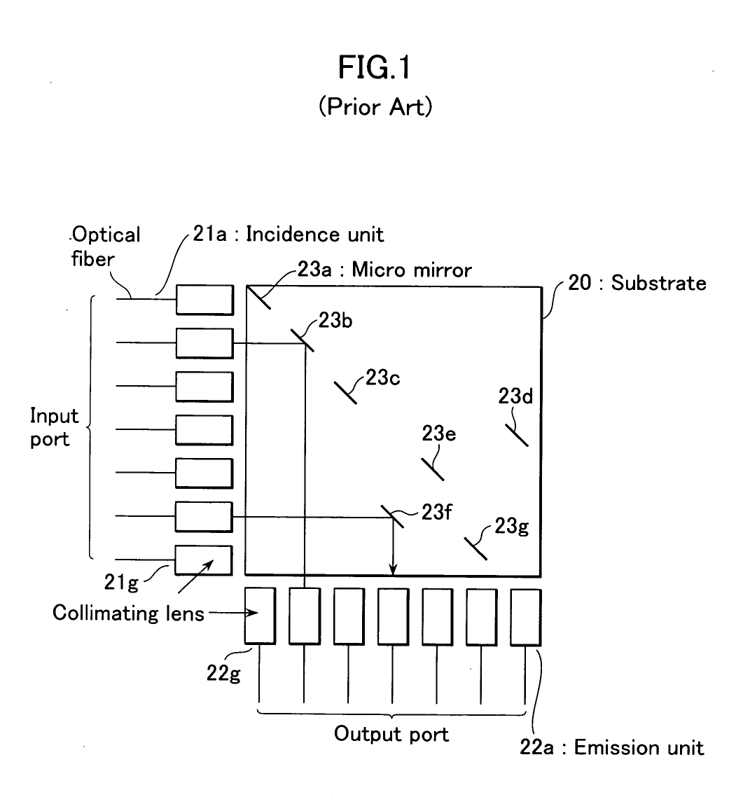

The same elements as in the conventional example shown in FIG. 1 are denoted by the same symbols and numerals. 1a represents a P⁺⁺GaAs-based compound semiconductor substrate on which the optical waveguide 7 shown in FIG. 2 and plural (in FIG. 4, 7×7) triangular electrode 5 are formed. Each of the plural upper electrodes 5 has its one side arranged at right angles to the incidence unit 21, at a cross point on the optical waveguide where lines extending from the n incidence units and n emission units intersect each other. A voltage application unit 8a is to apply a voltage between the upper electrodes 5 and the lower electrode 6. It has a function of controlling the voltage and an algorithm function.

The traveling direction of light passing through the optical waveguide in a two-dimensional plane is controlled by controlling the intensity of the voltage applied between the upper electrodes 5 and the lower electrode 6 or by controlling the position of incidence of incident light on the optical waveguide 7 situated below the triangular upper electrodes 5 or the diameter of the incident light.

In FIG. 4, light incident on the incidence unit 21 becomes incident on the core layer 3 (see FIG. 3) over the substrate 1a and travels straight within the optical waveguide 7 in a two-dimensional plane. When a voltage is applied to the upper electrode 5 existing at the cross point, the refractive index changes at that part of the optical waveguide. As a result, the traveling direction of light changes in the two-dimensional plane. The traveling direction of light changes, depending on the intensity of the applied voltage.

In FIG. 4, because of voltages applied to the electrodes 1-6 and 6-4, the traveling directions of light beams incident on the optical waveguide from the incidence units 21a, 21f are bent by changes in the refractive index of those parts of the optical waveguide 7, and the light beams become incident on the emission units 22b, 22d.

Therefore, by arranging n×n electrodes corresponding to n incidence units and n emission units, then applying a voltage to electrodes of arbitrary positions by the voltage application unit 8a using an appropriate algorithm, and thus controlling the refractive index in an optimum manner, it is possible to guide light incident on the core layer 3 from an incident unit to an arbitrary emission unit at a high speed without causing any loss.

The above description of this invention is simply the description of specific preferred examples for the purpose of explanation and illustration. Therefore, it should be understood by those skilled in the art that various changes and modifications can be made without departing from the scope of this invention.

For example, though triangular electrodes are used in the above-described examples, the electrodes may be circular or elliptical. While the clad layer is of P-type and the core layer is of N-type in the examples, the clad layer may be of N-type and the core layer may be of P-type.

Moreover, while 7×7 upper electrodes 5 are used in the above-described example, forming a larger number of upper electrodes enables smoother control of the traveling direction of light.

It should be understood that the scope of this invention defined by the claims includes such changes and modifications.

As is specifically described above using the examples, according to this invention, electrodes are formed on both sides of a part of an optical waveguide and a voltage is applied between the electrodes to change the refractive index at the part of the optical waveguide where the electrode is formed. Therefore, the traveling direction of light can be changed.

Moreover, an optical waveguide formed on a substrate, plural electrodes formed on both sides of the optical waveguide, plural incidence units formed at one end of the substrate, and plural emission units formed at the other end are provided. A voltage applied to an arbitrary electrode of the plural electrodes is controlled to change the refractive index at the part of the optical waveguide where the electrode is formed. Light emitted from an arbitrary incidence unit and incident on a core of a substrate thus becomes incident on an arbitrary emission unit.

Since the position of incidence of incident light or the diameter of the incident light is controlled to emit light to an arbitrary emission unit, it is possible to realize an optical switch that has a high degree of freedom in control, is small-sized, has no moving part and has high reliability.

Moreover, by providing a voltage application unit with an algorithm-based optimization processing function in order to improve the responsiveness and the degree of freedom of the optical switch, it is possible to realize a highly flexible optical switch that can cope with, for example, changes in communication quantity and communication failure.

What is claimed is:

1. An optical path control device comprising an optical waveguide having a clad layer of P-type (or N-type) formed on a substrate and a core layer of N-type (or P-type) stacked on the clad layer, and electrodes formed on both sides of a part of the optical waveguide, wherein a voltage is applied between the electrodes to change the refractive index at the part of the optical waveguide where the electrode is formed.

2. An optical path control device comprising an optical waveguide having a clad layer of P-type (or N-type) formed on a substrate and a core layer of N-type (or P-type) stacked on the clad layer, plural electrodes formed on both sides of the optical waveguide, plural incidence units provided at one end of the substrate, and plural emission units provided at the other end, wherein a voltage applied to an arbitrary electrode of the plural electrodes is controlled to change the refractive index at the part of the optical waveguide where the electrode is formed, so that light emitted from an arbitrary incidence unit and incident on the optical waveguide becomes incident on an arbitrary emission unit.

3. The optical path control device as claimed in claim 1 or 2, wherein the upper electrode is formed in a triangular shape.

4. The optical path control device as claimed in claim 1 or 2, wherein the position of incident light incident on the optical waveguide or the spot diameter of the incident light is controlled, thereby controlling the optical path of light.

5. The optical path control device as claimed in claim 2, wherein an algorithm function for realizing optimum control is used in order to selectively emit light from an arbitrary incidence unit to an arbitrary emission unit.
